(19) United States
(12) Patent Application Publication
(10) Pub. No.: US 2011/0184938 A1
(43) Pub. Date: Jul. 28, 2011

(54) DETERMINING SIMILARITY BETWEEN SOURCE CODE FILES

(76) Inventor: Tom HILL, Dallas, TX (US)

(21) Appl. No.: 12/694,738

(22) Filed: Jan. 27, 2010

(51) Int. Cl. G06F 7/08; G06F 17/30

(52) U.S. Cl. 707/722; 707/780; 707/E17.014

(57) ABSTRACT

According to one aspect of embodiments of the present invention, there is provided a computer system for determining similarity between a plurality of source code files. The computer system comprises a processor adapted to execute stored instructions, and a memory device that stores instructions for execution by the processor. The memory device comprises computer-implemented code adapted identify, in each of the plurality of source code files, data storage elements defined therein, determine which of the identified data storage elements are shared data storage elements, determine, for pairs of the source code files, the coincidence of the identified shared data storage elements, and identify pairs of the source code files as being similar based on the determined coincidence.

### BACKGROUND

Simple software applications may be defined in a single source code file, whereas complex software applications may have many thousands of source code files defining many thousands or millions of lines of programming instructions.

Over time, modifications may be made to software applications, for example to fix bugs, to make improvements, or to add functionality, etc. However, maintenance of software applications is complex and labor intensive, especially for large software applications.

### BRIEF DESCRIPTION

Embodiments of the invention will now be described, by way of non-limiting example only, with reference to the accompanying drawings, in which:

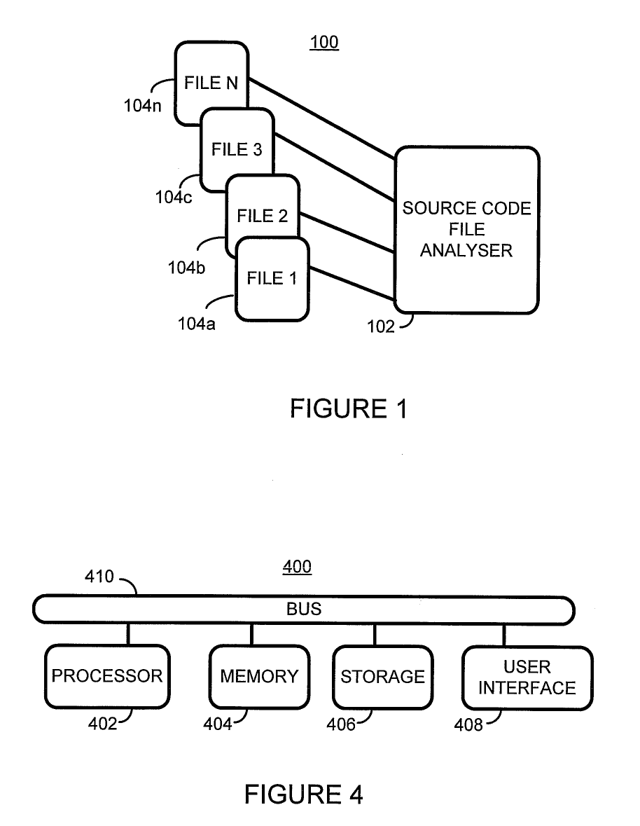

FIG. 1 is a simplified block diagram of a source code file analyzer according to one example of the present invention;

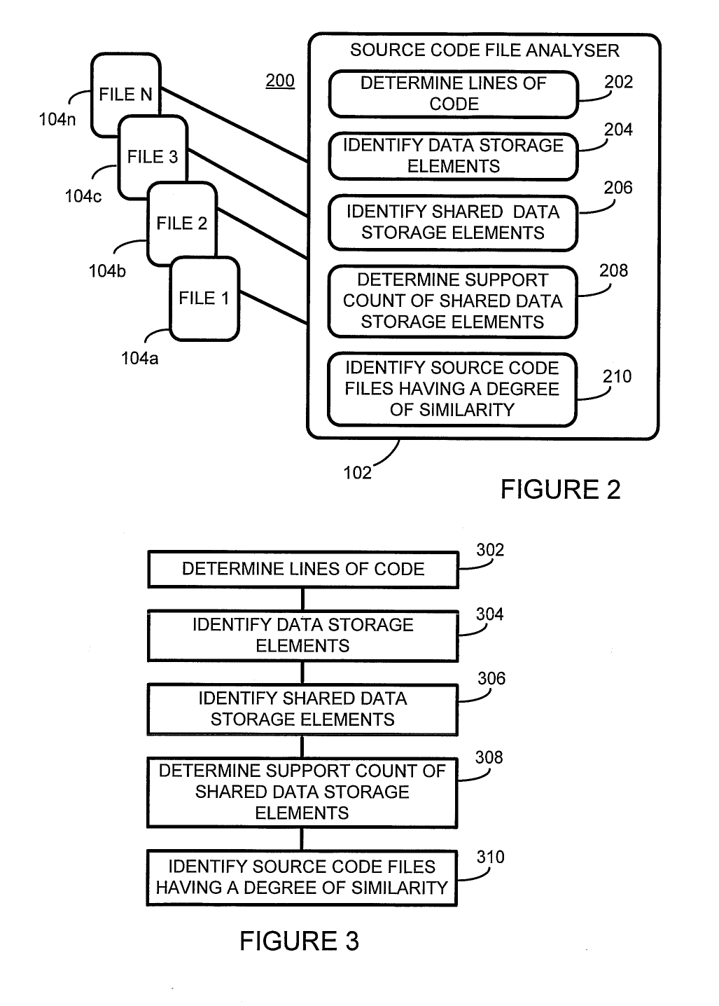

FIG. 2 is a simplified block diagram showing a source code file analyzer in greater detail according to one example of the present invention;

FIG. 3 is a simplified flow diagram outlining an example method of operating a source code file analyzer according to an embodiment of the present invention; and

FIG. 4 is a simplified flow diagram showing an example processing system on which a source code file analyzer according to an embodiment of the present invention may be implemented.

### SUMMARY OF THE INVENTION

According to one aspect of embodiments of the present invention, there is provided a computer system for determining similarity between a plurality of source code files. The computer system comprises a processor adapted to execute stored instructions, and a memory device that stores instructions for execution by the processor. The memory device comprises computer-implemented code to identify, in each of the plurality of source code files, data storage elements defined therein, to determine which of the identified data storage elements are shared data storage elements; to determine, for pairs of the source code files, the coincidence of the identified shared data storage elements, and to identify pairs of the source code files as being similar based on the determined coincidence.

According to a second aspect of embodiments of the present invention, there is provided a tangible, machine-readable medium that stores machine-readable instructions executable by a processor to determine similarity between a plurality of source code files. The tangible, machine-readable medium comprises machine-readable instructions that, when executed by the processor, identify data storage elements in each of the plurality of source code files, that identify which of the identified data storage elements are shared data storage elements; that determine, the coincidence of the identified shared data storage elements between different pairs of the plurality of source code files; and that identify pairs of the source code files as being similar based on the determined coincidence.

### DETAILED DESCRIPTION

As maintenance is performed on software applications this leads to application source code files being modified from their original state. Different people within an organization may modify different source code files, and in many organizations it common for different people to modify the same the source code file. Over time, this may lead to some source code files being duplicated and modified many different times by different people. Furthermore, where software applications have long useful life spans the modifications are more likely to be difficult to track and insufficiently documented.

Given that complex software applications may be defined by many hundreds of inter-related source code files defining many thousands or millions of lines of programming instructions, it is generally not possible to perform a manual review of the source code files to generate an understanding of how the different source code files relate to one another.

One aim of embodiments of the present invention is provide a method and apparatus for determining similarity between source code files.

Embodiments of the present invention are based on the realization that the determination of similarity between different source code files may be made without having to understand the whole functionality of a source code file, and without having to derive a syntactical understanding of a source code file. Such an approach is particularly advantageous since it is difficult and complex for computers to analyze source code files to determine the functionality or purpose of a source code file.

Referring now to FIG. 1 there shown a simplified block diagram of a source code file analyzer 102 according to one example of the present invention.

The source code file analyzer 102 is configured to analyze a plurality of source code files 104a to 104n. The source code files 104a to 104n are source code files defining a software application. The source code file analyzer 102 analyzes the source code contained in each source code file 104a to 104n to determine whether any similarity between any of the source code files exists. As described further below, the determination of similarity is based primarily on the coincidence of shared data storage elements in different source code files. A data storage element may include, for example, a variable, a data structure, a table, a file, or the like.

In other embodiments, the determination of similarity may be based on the coincidence of any other identifiable and countable metrics with a source code file, such countable metrics including, for example, the number of if statements, number of loops, etc.

If any degree of similarity is determined between source code files those files are suitably identified as having a degree of similarity. The source code file analyzer 102 may identify any source code files determined as having a degree of similarity, for example, by displaying or presenting an ordered list of such files on a suitable output device, by creating an output file containing a list of such source code files, or in any other suitable manner. The analyzer 102 may additionally assign a degree of similarity value to source code files.

As shown in FIG. 2, the source code analyzer 102 comprises a number of logical modules 202, 204, 206, 208 and 210, the operation of which is described with further reference to FIG. 3.

Module 202 takes a first source code file, such as source code file 104a, and determines (step 302), the number of lines of programming instructions contain therein.

Depending on the programming language in which the source code files are written the nature of the programming instructions may vary. However, most programming languages use a predefined syntax for programming comments in a source code file. For example, in COBOL comments are defined by a ‘*’ (asterix), and in C++ comments must be prefixed with a ‘//’ (double slash). Such programming comments are ignored when source code files are compiled or are interpreted.

In the present example, the number of lines of programming instructions in a source code file is determined, for example, by parsing the source code file and by counting the number of lines in the source code file, but not counting any lines of comments. In this way, module 202 does not have to be configured to understand all of the different programming instructions and constructs defined by a programming language, but only has to be configured to understand the syntax used for defining programming comments.

The results of the line count may be stored in a suitable array, data structure, database, file, or the like, either in memory or in an external storage medium. Table 1 shows an example database table in which the line count data may be stored.

TABLE 1
Determined lines of code

| FILENAME | LINES OF CODE |
|---|---|
| File1 | 669 |
| File2 | 672 |
| File3 | 730 |
| File4 | 719 |
| File5 | 706 |

Module 204 identifies (step 304) any data storage elements defined in each source code file, for example, by suitably parsing each source code file. The module 204 is appropriately configured for the particular programming language in which the source code files are written. As is known in the art, different programming languages use different syntaxes for declaring data storage elements. For example, C variables and data structures may include, for example, char, short, int, long, long long, and may be prefixed by signed or unsigned. For example, the C programming instruction int account_balance defines the data variable account_balance as being an integer data type.

In the present embodiment the data storage elements identified by module 204 and at step 304 are data structures. However, in other embodiments both simple variables and data structures may be identified.

Tables 2a, 2b, and 2c below show example tables used for storing the data structures identified in the source code files 104a, 104b, and 104c.

TABLE 2a
Data structures found in File1
DATA STRUCTURES - File1

```
EMPLOYEE_DATA_STRUCTURE
    CHAR EMPLOYEE_NAME
    INT EMPLOYEE_NUMBER
JOB_DATA_STRUCTURE
    CHAR JOB_TITLE
    INT JOB_NUMBER
    CHAR JOB_LOCATION
...
```

TABLE 2b
Data structures found in File2
DATA STRUCTURES - File2

```
EMPLOYEE_DATA_STRUCTURE
  CHAR EMPLOYEE_NAME
  INT EMPLOYEE_NUMBER
JOB_DATA_STRUCTURE
    CHAR JOB_TITLE
    INT JOB_NUMBER
    CHAR JOB_LOCATION
...
```

TABLE 2c
Data structures found in File3
DATA STRUCTURES - File3

```
EMPLOYEE_DATA_STRUCTURE
  CHAR EMPLOYEE_NAME
  INT EMPLOYEE_NUMBER
JOB_DATA_STRUCTURE
    CHAR JOB_TITLE
    INT JOB_NUMBER
    CHAR JOB_LOCATION
...
```

Module 206 then determines (step 306) or identifies, which of the identified data storage elements are shared data storage elements. For clarity, the term shared data storage element is used herein to define a data storage element that is used to pass data between program modules defined by different source code files. A shared data storage element may include, for example, a variable or data structure which is committed or stored in a shared storage medium. A shared storage medium may include, for instance, a shared memory, a stack, a heap, a file on a shared disk, a file on a remote file server, and the like.

In the present embodiment a shared data storage element is determined by parsing or analyzing a source code file to determine whether an identified data storage element is included in any program code instruction relating to input/output operations that could cause that shared data storage element to be committed or stored to a shared storage medium. Example instructions include program code instructions that perform a write, a read, a select, an insert, an update, a delete, a sending, a receiving, etc. to a disk, a database table, to a screen, to a window, to a report, to a socket, etc. In the present embodiment no determination is made as to where the data storage element is stored, only that it is committed to some shared data storage.

For example, in the C programming language a data storage element may be determined as being a shared data storage element by identifying a data storage element in a WRITE statement, such as:

WC = WRITE (OUTDISK, EMPLOYEE_DATA_STRUCTURE,
RECLEN);
or
WC = WRITE (OUTREPORT, JOB_DATA_STRUCTURE, RECLEN);

Table 3 below shows an example database table showing identified shared data storage elements.

TABLE 3
Shared data storage elements
SHARED DATA STORAGE
ELEMENTS

```
EMPLOYEE_DATA_STRUCTURE
  CHAR EMPLOYEE_NAME
  INT EMPLOYEE_NUMBER
JOB_DATA_STRUCTURE
    CHAR JOB_TITLE
    INT JOB_NUMBER
    CHAR JOB_LOCATION
...
```

Module 208 then performs a pair-wise comparison of each source code file to determine the coincidence, or support count, of the identified shared data storage elements common between each pair of source code files.

For example, a pair-wise comparison of File1 and File2 is performed to determine which shared data storage elements are common between File1 and File2 (in this case the data structures EMPLOYEE_DATA_STRUCTURE and JOB_DATA_STRUCTURE). The number of shared data storage elements in File1 found in File2 is given as the shared data storage element support count for File1.

Those skilled in the art will appreciate that the examples given herein have been simplified for ease of understanding.

The support count data may be stored, for example, in table form as shown in Table 4 below

TABLE 4
Table showing pair-wise support count

| SUPPORT | PRIMARY | SECONDARY |
|---|---|---|
| COUNT | FILE | FILE |
| 19 | File4 | File2 |
| 40 | File1 | File3 |
| 10 | File4 | File3 |
| 39 | File 4 | File1 |
| 39 | File1 | File4 |
| 41 | File1 | File2 |
| . . . | . . . | . . . |

In one embodiment, module 210 uses the determined data, such as the data shown in Table 4, to identify (step 310) which of the source code files are deemed to be similar to one another. For example, module 210 may sort the data in Table 4 such that source code program files having the highest support count are shown at the top of the table, as shown for example in Table 5.

Module 210 may remove duplicate entries from the table. For example, the support count of File1 and File2 will be the same as the support count for File2 and File1.

TABLE 5
Determined data sorted by descending order of support count.

| SUPPORT | PRIMARY | SECONDARY |
|---|---|---|
| COUNT | FILE | FILE |
| 41 | File1 | File2 |
| 40 | File1 | File3 |
| 39 | File1 | File4 |
| 19 | File4 | File2 |
| 10 | File4 | File3 |
| . . . | . . . | . . . |

The contents, or a part of the contents, of the table 5 may be presented to a user, for example by way of a list, through a suitable output device such as a display device. In this way, a user can quickly identify which of the source code files are most similar.

Being able to determine similarity between source code files is important in software maintenance. For example, by knowing which source code files are similar enables updates made to one source code file to be made to all other similar source code files. Likewise, where source code files are to be migrated or ported to a different programming language, being able to identify similarity greatly facilitates migration.

In a further embodiment, the data stored in Table 4 may be augmented by additional data, such as by adding the previously determined lines of code count for both pairs of files compared, along with the total number of data storage elements identified in each of the pairs of files, as shown below in FIG. 6.

TABLE 6
Table showing pair-wise support count and additional data

| | | | PRIMARY | SECONDARY | PRIMARY | SECONDARY |
|---|---|---|---|---|---|---|
| SUPPORT | PRIMARY | SECONDARY | FILE LINE | FILE LINE | DATA | DATA |
| COUNT | FILE | FILE | COUNT | COUNT | STRUCTURES | STRUCTURES |
| 19 | File4 | File2 | 719 | 672 | 48 | 43 |
| 39 | File1 | File4 | 669 | 719 | 41 | 48 |
| 19 | File4 | File2 | 719 | 672 | 48 | 43 |
| 10 | File4 | File3 | 719 | 730 | 48 | 42 |
| 41 | File1 | File2 | 669 | 672 | 41 | 43 |
| 40 | File1 | File3 | 669 | 730 | 41 | 42 |
| . . . | . . . | . . . | . . . | . . . | . . . | . . . |

Module 210 uses the determined data, such as the data shown in Table 6, to identify (step 310) which of the source code files are deemed to have a degree of similarity to one another. For example, module 210 may sort the data in Table 6 such that source code program files having the highest support count are shown at the top of the table, as shown for example in Table 7.

TABLE 7
Sorted table showing pair-wise support count and additional data

| | | | PRIMARY | SECONDARY | PRIMARY | SECONDARY |
|---|---|---|---|---|---|---|
| SUPPORT | PRIMARY | SECONDARY | FILE LINE | FILE LINE | DATA | DATA |
| COUNT | FILE | FILE | COUNT | COUNT | STRUCTURES | STRUCTURES |
| 41 | File1 | File2 | 669 | 672 | 41 | 43 |
| 40 | File1 | File3 | 669 | 730 | 40 | 42 |
| 39 | File1 | File4 | 669 | 719 | 41 | 48 |
| 19 | File4 | File2 | 719 | 672 | 48 | 43 |
| 10 | File4 | File3 | 719 | 730 | 48 | 42 |
| . . . | . . . | . . . | . . . | . . . | . . . | . . . |

The contents, or a part of the contents, of the table 5 may be presented to a user, for example by way of a list, through a suitable output device such as a display device.

In a yet further embodiment the data in Table 6 or Table 7 may be additionally sorted by descending number of primary and secondary line counts. In this way, program files appearing at the top of the table are those which are determined have the highest degree of similar to one another.

In one embodiment, module 210 identifies source code files which have the highest degree of similarity by identifying those source code files having the highest support count.

In a further embodiment, module 210 identifies source code files have the highest degree of similarity by identifying those source code files having the highest ratio of support count to total number of shared data storage elements.

In a still further embodiment, module 210 calculates a degree of similarity value based on the identified support count. Such a value may be calculated, for example, based on the determined support count and the number of shared data storage elements identified in each of a pair of source code files. In other embodiments, the determined line count or other determined metrics may be used in the calculation of the degree of similarity value.

In a yet further embodiment, module 210 ranks the list of determined source code files based on the primary file line count.

In a yet further embodiment, prior to the processing or analysis of a source code file by any of modules 202 and 206, any ‘include’ type statements contained in a source code file are processed to append any additional source code files referenced by any such ‘include’ statements to the source code file concerned. For example, in the C programming language the #include “filename.h” directive will be detected by the module 210 and the contents of the file filename.h will be appended to the source code file containing that include directive prior to the module 210 determining the number of lines of code of that source file and prior to the module 210 determining the data structures in that source file. The processing of such include statements is recursive, such that any source code files included by way of an include type statement are also parsed or analyzed for further include statements.

The source code analyzer 102 may, for example, be suitably implemented in hardware or software.

For example, the source code analyzer modules 202, 204, 206, 208 and 210 may be implemented by way of programming instructions stored on a computer readable storage medium 404 or 406. The memory 404 and storage 406 is coupled to a processor 402, such as a microprocessor, through a communication bus 410. The instructions, when executed by the processor 402 provide the functionality of a source code file analyzer as described above by executing the above-described method steps. The identification of determined similar source code files may be made, for example, via a user interface 408 coupled to the processor 402 by the bus 410.

Although the above-described operations are described as linear operations, it should be noted that in further embodiments one or more of the above-described operations may be performed in parallel. It should be further noted that not all of the above-described steps are required in all of the embodiments.

It will be appreciated that embodiments of the present invention can be realized in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine readable storage storing such a program. Still further, embodiments of the present invention may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A computer system for determining similarity between source code files, the computer system comprising:
a processor adapted to execute stored instructions; and
a memory device that stores instructions for execution by the processor, the memory device comprising computer-implemented code adapted to:
identify, in each of a plurality of source code files, data storage elements defined therein;
determine which of the identified data storage elements are shared data storage elements;
determine, for pairs of the source code files, the coincidence of the identified shared data storage elements; and
identify pairs of the source code files as being similar based on the determined coincidence.

2. The computer system of claim 1, wherein the code to determine the coincidence is adapted to determine the support count of the identified shared data storage elements.

3. The computer system of claim 1, wherein the code to identify data storage elements is adapted to identity at least one of: variables; and data structures.

4. The computer system of claim 1, wherein the code to determine which of the identified data storage elements are shared data storage elements is adapted to determine which of the identified data storage elements are committed to or obtained from a storage medium.

5. The computer system of claim 4, wherein the code to determine which of the identified data storage elements are shared data storage elements comprises code for identifying an identified data storage element within one of a plurality of pre-determined programming instructions.

6. The computer system of claim 1, wherein the code further comprises code to determine, for each of the plurality of source code files, the number of lines of programming instructions contained therein.

7. The computer system of claim 1, wherein the code to identify pairs of the source code files as being similar further comprises code to present a list of identified similar pairs of source code files to a user, the list being sorted by descending similarity.

8. The computer system of claim 1, wherein the code to identify pairs of the source code files as being similar further comprises code for calculating, using at least the determined coincidence and the determined number of data storage elements, a similarity degree value, and for presenting the calculated similarity degree value to a user through a display device.

9. A tangible, machine-readable medium that stores machine-readable instructions executable by a processor to determine similarity between a plurality of source code files, the tangible, machine-readable medium comprising:
machine-readable instructions that, when executed by the processor, identify data storage elements in each of the plurality of source code files;
machine-readable instructions that, when executed by the processor, identify which of the identified data storage elements are shared data storage elements;
machine-readable instructions that, when executed by the processor, determine the coincidence of the identified shared data storage elements between different pairs of the plurality of source code files; and
machine-readable instructions that, when executed by the processor, identify pairs of the source code files as being similar based on the determined coincidence.

10. The tangible, machine-readable medium of claim 9, wherein the machine-readable instructions to determine the coincidence are adapted to determine the support count of the identified shared data storage elements.

11. The tangible, machine-readable medium of claim 9, wherein the machine-readable instructions to identify data storage elements are adapted to identity at least one of: variables; and data structures.

12. The tangible, machine-readable medium of 9, wherein the machine-readable instructions to determine which of the identified data storage elements are shared data storage elements are adapted to determine which of the identified data storage elements are committed to or obtained from a storage medium.

13. The tangible, machine-readable medium of claim 12, wherein the machine-readable instructions to determine which of the identified data storage elements are shared data storage elements comprise machine-readable instructions for identifying an identified data storage element within one of a plurality of pre-determined programming instructions.

14. The tangible, machine-readable medium of 9, wherein the machine-readable instructions further comprise instructions to determine, for each of the plurality of source code files, the number of lines of programming instructions contained therein.

15. The tangible, machine-readable medium of 9, wherein the machine-readable instructions to identify pairs of the source code files as being similar further comprise machine readable instructions to present a list of identified similar pairs of source code files to a user, the list being sorted by descending similarity.

16. The tangible, machine-readable medium of 9, wherein the machine-readable instructions to identify pairs of the source code files as being similar further comprise machine readable instructions to calculate, using at least the determined coincidence and the determined number of data storage elements, a similarity degree value, and to present the calculated similarity degree value to a user through a display device.
